(19) United States
(12) Patent Application Publication
(10) Pub. No.: US 2005/0052439 A1
(43) Pub. Date: Mar. 10, 2005

(54) Gate drive device for a display

(75) Inventor: Chang-Ho Liou, Shetou Shiang (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/673,504

(22) Filed: Sep. 30, 2003

(30) Foreign Application Priority Data
Aug. 22, 2003 (TW) 092123231

(51) Int. Cl. G09G 5/00

(52) U.S. Cl. 345/204

(57) ABSTRACT

The present invention relates to a gate drive device for a display. In the display, a timing control register is installed for rearranging the image signal data transmitted by a back end circuit of the display, and changing the open directions of the scan lines of each of the divided panel areas to the opposite directions by means of the image signal data transmitted to the display panel so as to resolve the problem of RC-delay, which makes the display image have uneven color in the jointing portion between the scan line gate drivers and makes the frame shift, caused by the excessive length of the scan line circuits of the display panel.

### BACKGROUND OF THE INVENTION

1. Field of the Invention

The present invention relate to a gate drive device for a display using a timing control register for rearranging the image signals transmitted by the back end circuit of the display panel so as to change the open directions of the scan lines. Therefore, the appearance of the uneven color and frame shifting on the display frame caused by the RC-delay of the panel can be resolved.

2. Description of the Prior Art

In the conventional liquid crystal display panel, the gate drivers of a plurality of scan lines are controlled, and because the effects of the coupled capacitance (C) and the resistance (R) between the data lines and the scan lines on the display panel, the RC-delay appearance of the panel circuit is caused. This is because when the scan lines are opened sequentially from one end to the other end of the panel, the voltage for the signal transmission on the panel will be affected by the inside resistance on the circuit and panel so as to make the capacitance of the liquid crystal display charged insufficiently and cause the difference between the open timings of the scan lines. Therefore, the display image has uneven color and shifting frame in the jointing portion between the scan line gate drivers.

FIG. 1 is a perspective diagram of a prior art drive circuit for a display panel. A gate driver 11 and a data driver 12 are separately installed on the two sides of the liquid crystal display panel 10. The gate driver 11 is connected to a plurality of scan lines 13 of the panel 10, and the data driver 12 is connected to a plurality of data lines 14 of the panel 10. Each of the scan lines 13 and the data lines 14 is connected to thin film transistors 15, 15′ with corresponding display pixels. When the gate driver 11 sequentially opens the plurality of scan lines 13, and the data driver 12 uses the image signals sent from the data lines 14 to open the thin film transistors 15, 15′. The thin film transistors are used for charging/discharging the storing capacitances of the display electrodes (the display liquid crystal). During the operation of the display panel 10, the gate driver 11 sends the voltages via the panel circuit for opening the thin film transistors 15, 15′, and the open direction is shown as the arrow 16. Because of the RC-delay, the preceding thin film transistor 15 will affect the driving of the following thin film transistor 15′ so as to affect the liquid crystal drive voltage of the whole liquid crystal display panel 10. Particularly, the uneven appearance of the display frame on the large size panel caused by the RC-delay will be more obvious.

In order to improve the appearance of uneven display caused by the RC-delay on the panel, the prior art technology applies more than two gate drivers for reducing this drawback. Please refer to FIG. 2A. FIG. 2A is a perspective diagram of a plurality of prior art gate drivers for a display panel. The display panel is divided into a first panel 10a (an upper portion) and a second panel 10b (a lower portion). The gate driver is divided into a first gate driver 11a at the upper and a second gate driver 11b at the lower. The data driver is divided into a first data driver 12a at the upper and a second data driver 12b at the lower. The first gate driver 11a is connected to a plurality of scan lines 13a on the first panel 10a, and the first data driver 12a is connected to a plurality of data lines 14a on the first panel 10a. The second gate driver 11b is connected to a plurality of scan lines 13b on the second panel 10b, and the second data driver 12b is connected to a plurality of data lines 14b on the second panel 10b. This panel circuit uses the first control circuit 20a for controlling the signal timing of the first gate driver 11a and the first data driver 12a for the first panel 10a, and for controlling the open timings of the scan lines by the second gate driver 11b. The timing control of the first control circuit 20a is used for starting the first gate driver 11a and the second gate driver 11b so as to separately open the starting timings of the scan-lines 13a, 13b. In addition, a second control circuit 20b is used for controlling the image signals of the second data driver 12b of the second panel 10b so that the open directions of the scan lines 13a, 13b for the first panel 10a and second panel 10b are shown as the arrows 21, 22. Namely, the thin film transistors are sequentially opened from upper to lower so as to reduce the appearance of uneven color and sifting frame on the display caused by the RC-delay on the panel circuit.

The prior art technology in FIG. 2A applies a plurality of gate drivers for reducing the display fault, but when transmitting the display signals, the first gate driver 11a sequentially opens the scan lines 13a from upper to lower, and at the same time, the second gate driver 11b sequentially opens the scan lines 13b from upper to lower. The open timings for the scan lines are show in FIG. 2B. The square waves represent the pulse for the open timings. When the last scan line of the scan lines 13a of the first panel 10a is opened, the next scan line to be opened is the first scan line of the second panel 10b. Because the open timings for the scan lines in the jointing portion of the two gate drivers 11a, 11b are different, the appearance of the RC-delay in the circuit existing, and the charging voltages of the display capacitances are different, the problems of uneven color and shifting image will appear in the jointing portion of the display.

In order to improve the drawbacks of the prior art display panel, the present invention applies a memory register in a display for rearranging the image signals transmitted by the back end circuit of the display. Therefore, the open directions of the scan lines on the panel will be changed so as to resolve the problems of the prior art display image.

### SUMMARY OF THE INVENTION

The present invention relates to a gate drive device for a display. In the display, a register is installed for rearranging the image signal data transmitted by a back end circuit of the display, and changing the open directions of the scan lines of each of the divided panel areas to the opposite directions by means of the image signal data transmitted to the display panel so as to resolve the problem of RC-delay, which makes the display image have uneven color in the jointing portion between the scan line gate drivers and makes the frame shift, caused by the excessive length of the scan line circuits of the display panel.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a prior art drive circuit for a display panel;

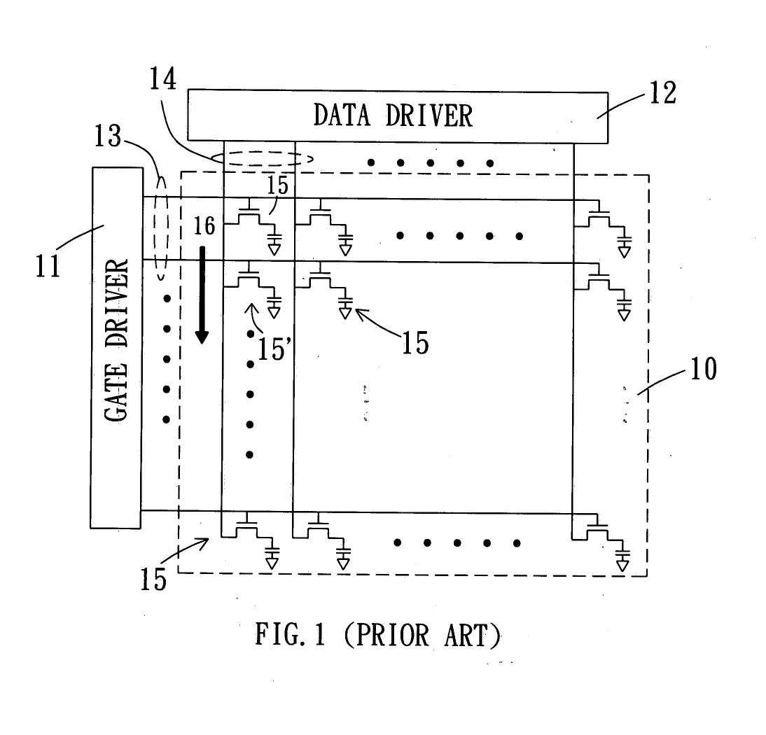

FIG. 2A is a perspective diagram of a plurality of prior art gate drivers for a display panel;

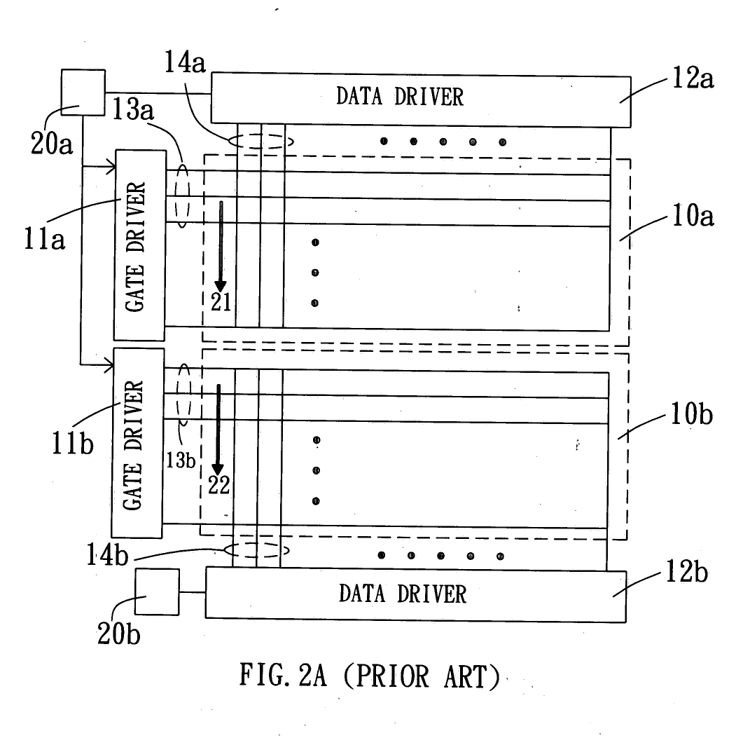

FIG. 2B is a perspective diagram of timing clocks of scan lines of prior art gate drivers for a display panel;

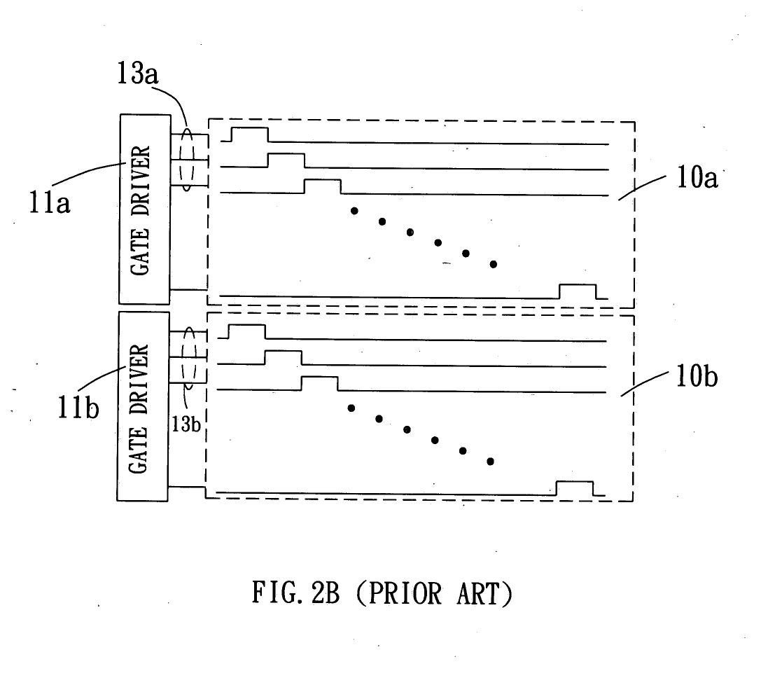

FIG. 3A is a perspective diagram of a gate drive device for a display according a first embodiment of the present invention;

FIG. 3B is a perspective diagram showing the open timings of scan lines according the first embodiment of the present invention;

FIG. 4A is a perspective diagram of a gate drive device for a display according a second embodiment of the present invention;

FIG. 4B is a perspective diagram showing the open timings of scan lines according the second embodiment of the present invention; and

FIG. 5 is a perspective diagram showing the open timings of scan lines of a gate drive device for a display according a third embodiment of the present invention.

### DETAILED DESCRIPTION OF THE PREFERRED EMBODIMENT

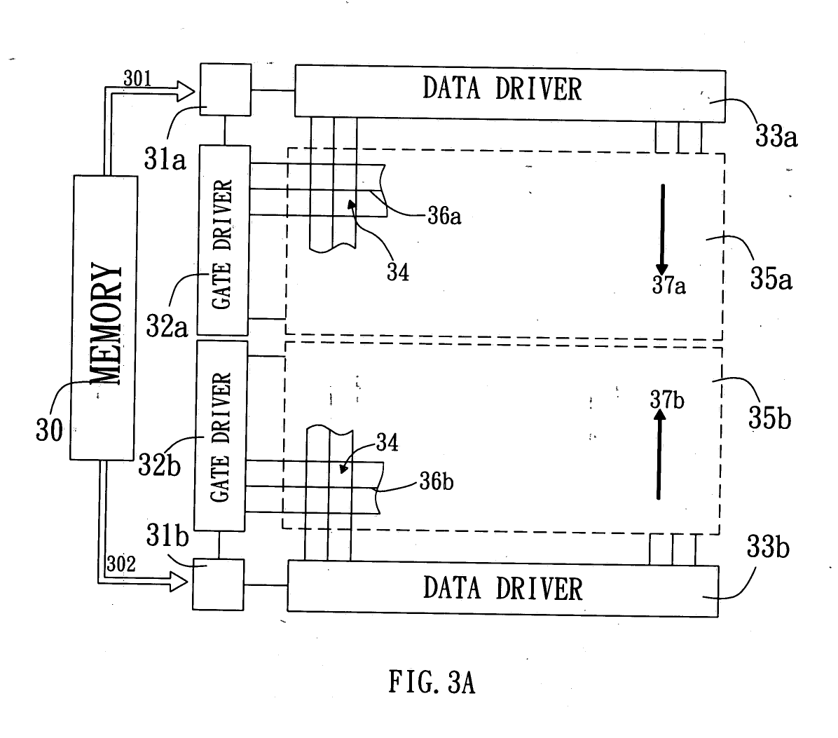

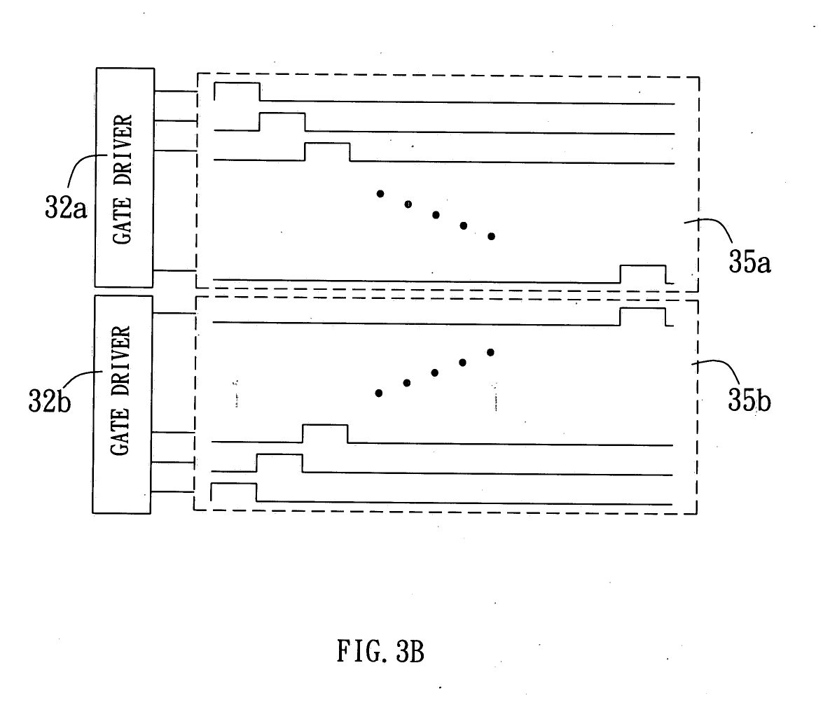

FIG. 3A is a perspective diagram of a gate drive device for a display according a first embodiment of the present invention. A display panel is divided into an upper and a lower portions of division panels 35a, 35b. A plurality of gate drivers are provide for connecting and controlling a plurality of scan lines of the display panel. The gate drivers 32a, 32b are separately operated for separately driving the two portions of the plurality of scan lines 36a, 36b of the display panel so as to resole the problems of uneven color and image shift on the panel caused by the RC-delay appearance.

As shown in FIG. 3A, a first control circuit 31a is connected to a first data driver 33a and a first gate driver 32a of a first division panel 35a for controlling the open timings of the data lines and the scan lines. Similarly, a second control circuit 31b is connected to a second data driver 33b and a second gate driver 32b of a second division panel 35b for controlling the open timings of the data lines and the scan lines. The first gate driver 32a is used for controlling the open timings of the thin film transistors 34 on the plurality of scan lines 36a in the first division panels 35a. As shown by the arrow 37a, the open direction is from upper to lower. The second gate driver 32b is used for controlling the open timings of the thin film transistors 34 on the plurality of scan lines 36b in the second division panels 35b, and the open direction is from lower to upper shown as the arrow 37b.

In order to resolve the problem of uneven display caused by the inaccuracy of the open timings of the scan lines in the joining portion on the upper and lower division panels when the two portions of the gate drivers 32a, 32b are operated, the present invention applies a timing control register 30 for temporarily storing image starting signals transmitted in the display panel 35a, 35b and then rearranging the signal sequence to be separately transmitted to a first control circuit 31a via a first control line 301 and to a second control circuit 31b via a second control line 302. Therefore, the starting signals of the scan lines transmitted to the gate driver 32a, 32b by the two control circuits are rearranged, and the open direction of the scan lines 36aof the first division panel 35a is opposite to the open direction of the scan lines 36b of the second division panels 35b as shown by the arrows 37 and 38.

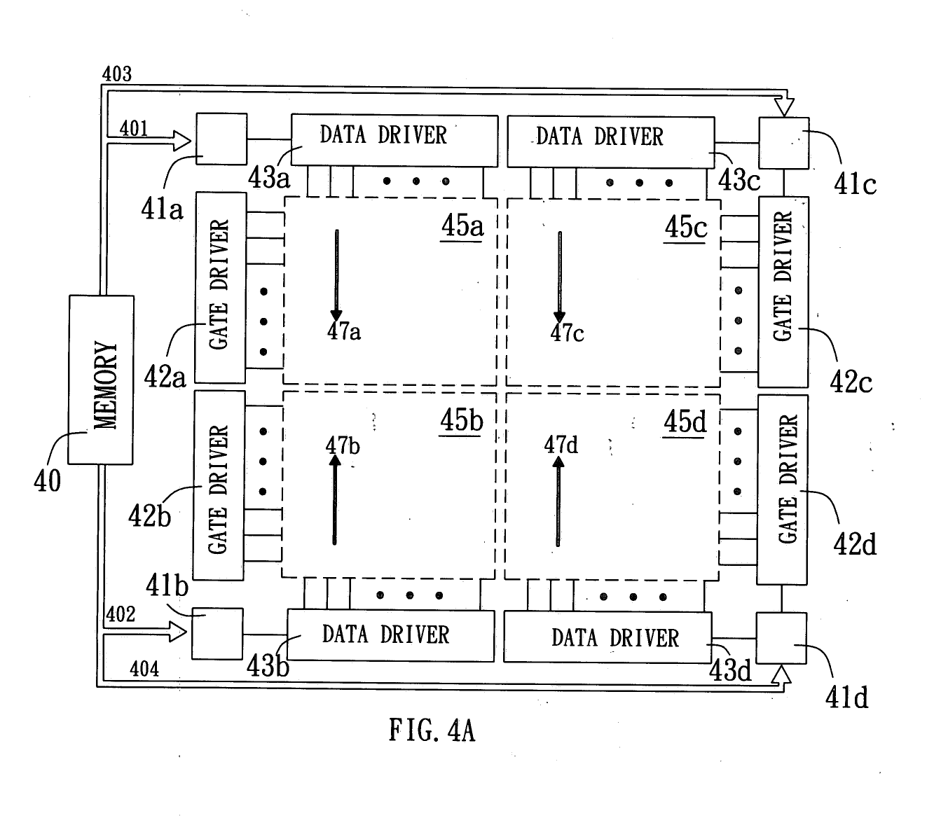

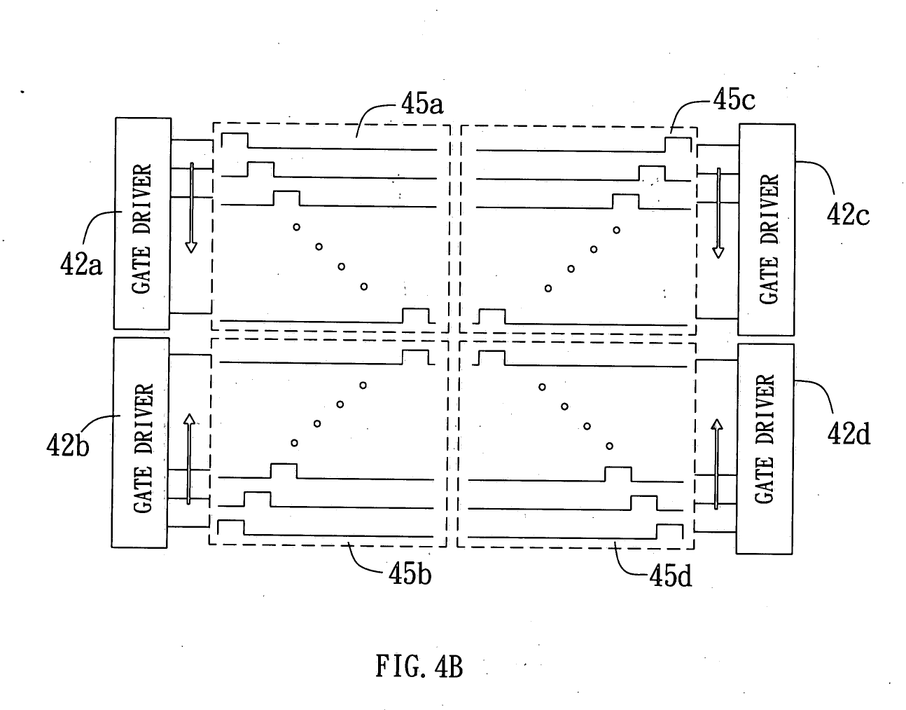

FIG. 3B is a perspective diagram showing the open timings of the scan lines according the first embodiment of the present invention. When the image signals are sent to the timing control register 30, the open sequences of the scan lines are rearranged to be transmitted to the first control circuit 31a via the first control line 301 so that the first gate driver 32a will drive the open timings of the scan lines in the first division panels 35a. As shown by the square waves, the scan lines are sequentially opened from upper to lower. The open sequences of the scan lines are transmitted to the second control circuit 31b via the second control line 302 so that the second gate driver 32b will drive the open timings of the scan lines of the second division panel 35b. As shown by the square waves, the scan lines are sequentially opened from lower to upper. As a result, when each of the frames in the display panel is updated, the timing control register 30 will control the upper and lower gate drivers 32a, 32b at the same time. The scan lines are opened beginning from the upper and lower ends. The total openness for the scan lines is accomplished in the joining portion between the gate drivers. Because the open timings of the thin film transistors on the scan lines are the same, the display inaccuracy caused by the RC-delay will not appear on the image of the joining portion. The open direction of the scan lines in the first division panels 35a is from upper to lower and the open direction of the scan lines in the second division panels 35b is from lower to upper, and therefore, the last scan lines in the two portions 35a, 35b are opened at the same time. FIG. 4A is a perspective diagram of a gate drive device for a display according a second embodiment of the present invention. Similar to the technology in FIG. 3A, the display panel is divided into a first division panels 45a, a second division panels 45b, a third division panels 45c and a fourth division panels 45d. The timing control register 40 is used for temporarily storing the open sequences of the scan lines for the display image signals. After the open sequences of the scan lines for the image signals are rearranged, they are transmitted to the first control circuit 41a via the first control line 401, to the second control circuit 41b via the second control line 402, to the third control circuit 41c via the third control line 403, to the fourth control circuit 41d via the fourth control line 404. Then, the plurality of control circuits 41a, 41b, 41c, 41d will transmit the open sequences of the scan lines to the plurality of gate drivers 42a, 42b, 42c, 42d in the first division panels 45a, the second division panels 45b, in the third division panels 45c and the fourth division panels 45d, and the open directions of the scan lines are shown as the arrows 47a, 47b, 47c, 47d. The display panel is divided into several portions for being separately driven. Because the transmission paths of the image signals are shorten, the appearance of charging insufficiency of the liquid crystal capacitance caused by the RC-delay on the display panel circuit can be reduced. In addition, because the timing control register 40 rearranges the open sequences of the scan lines, the scan lines in the joining portion of the gate drivers for the upper-lower adjacent division panels are opened at the same time, the display inaccuracy will be avoided. As shown in the figure, the scan lines of the first division panel 45a are opened form upper to lower, the scan lines of the second division panel 45b opened from lower to upper, the scan lines of the third division panel 45c opened from upper to lower, and the scan lines of the fourth division panel 45d are opened from lower to upper. The open timings of the scan lines in the joining portion of the upper-lower adjacent division panels are the same, and the open timings of the scan lines in the joining portion of the left-right, adjacent division panels are the same, and therefore, the open timings for the scan lines in the joining portion of the panel are synchronous. In another embodiment, the timing control register 40 will rearrange the open sequences for the scan lines so that the scan lines of the first division panel 45a are opened from the lower to upper, the scan lines of the second division panel 45b opened from the upper to lower, the scan lines of the third division panel 45c opened form the lower to upper, and the scan lines of the fourth division panel 45d are opened from the upper to lower.

FIG. 4B is a perspective diagram showing the open timings of the scan lines according the second embodiment of the present invention. The plurality of square waves represent the pluses for the starting signals, and the open timings of the scan lines of the division panels 45a, 45b, 45c, 45d are controlled to be different so that the open timings of the scan lines in the joining portion of the upper-lower adjacent gate drivers are the same.

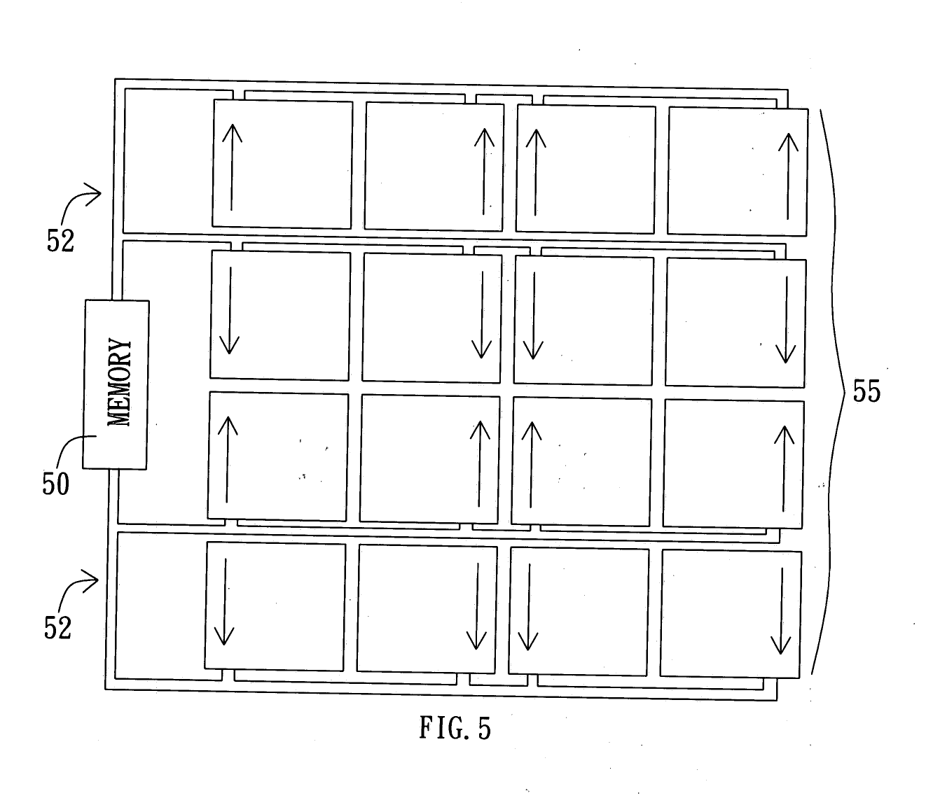

FIG. 5 is a perspective diagram showing the open timings of scan lines of a gate drive device for a display according a third embodiment of the present invention. The display panel 55 is divided into a plurality of division panels to be separately driven. The timing control register 50 is applied for rearranging the open sequences of the scan lines for displaying the image signals. A plurality of control lines 52 will transmit the starting signals of the scan lines to the plurality of control circuits of the division panels for controlling the plurality of gate drivers. Therefore, the open sequences of the scan lines in the division panels will be rearranged, and the scan lines in the joining portion of the gate drivers in the division panels will be opened at the same time so as to resolve the problem of display inaccuracy for the different open timings of the scan lines caused by the RC-delay.

The above is the detailed description of a gate drive device for a display according the embodiment of the present invention. The present invention applies a timing control register for rearranging the image signals transmitted by the back end circuit of the display which is divided into a plurality of division panels. Then, by using the image signals transmitted to the display panel, the open directions for the scan lines on the panel are changed so as to resolve the problem of display inaccuracy for the different open timings of the scan lines caused by the RC-delay.

Those skilled in the art will readily observe that numerous modifications and alterations of the device may be made while retaining the teachings of the invention. Accordingly, the above disclosure should be construed as limited only by the metes and bounds of the appended claims.

1. A gate drive device for a display, the open sequences for a plurality of scan lines in a panel being changed so that open sequences of the plurality of scan lines between the two adjacent gate drivers being the same, the drive device comprising:
a display panel being divided into a plurality of division panels;
a plurality of gate drivers being the gate drivers of the plurality of division panels;
a plurality of control circuits for connecting the data drivers and the gate drivers of the plurality of division panels; and
a timing control register connected to the plurality of control circuits by a plurality of control lines;
wherein the timing control register is used for controlling the open timings of the scan lines of the plurality of division panels.

2. The gate drive device of claim 1, wherein the open timings of the scan lines in the joining portions of the plurality of upper-lower adjacent division panels are the same.

3. The gate drive device of claim 1, wherein the open timings of the scan lines of the plurality of left-right adjacent division panels are the same.

4. The gate drive device of claim 1, wherein the timing control register is used for temporarily storing the image starting signals of the display panel.

5. The gate drive device of claim 1, wherein the gate drivers are connected to the plurality of scan lines of the display panel for controlling.
